(19) United States
(12) Patent Application Publication
(10) Pub. No.: US 2014/0121822 A1
(43) Pub. Date: May 1, 2014

(54) NUMERICAL CONTROLLER HAVING THREADING CYCLE FUNCTION

(71) Applicant: FANUC CORPORATION, Minamitsuru-gun (JP)

(72) Inventors: Makoto SUZUKI, Minamitsuru-gun (JP); Shuji OGAWA, Minamitsuru-gun (JP)

(73) Assignee: FANUC CORPORATION, Minamitsuru-gun (JP)

(21) Appl. No.: 14/057,383

(22) Filed: Oct. 18, 2013

(30) Foreign Application Priority Data
Oct. 30, 2012 (JP) 2012-239252

(51) Int. Cl. G05B 19/18

(52) U.S. Cl. CPC G05B 19/182
USPC 700/190

(57) ABSTRACT

A numerical controller has a threading cycle function that performs threading on a workpiece by repeating an operation in which a tool is positioned at a cutting start position based on a machining program designating a thread shape and is relatively moved in the workpiece axis direction with respect to the workpiece. By a threading instruction of the machining program, a cutting start position for each cycle is calculated so that the workpiece is sequentially cut in a direction opposite to the movement direction of the tool with respect to the workpiece. The tool is positioned at the cutting start position calculated for each cycle and the threading is performed on the workpiece.

### BACKGROUND OF THE INVENTION

1. Field of the Invention

The present invention relates to a numerical controller having a threading cycle function.

2. Description of the Related Art

As a thread shape cutting method in a threading cycle, single-edged cutting in which cutting operation is performed from a front side of a thread shape, as illustrated in FIG. 7, and zigzag cutting in which zigzag cutting operation is performed in zigzag manner in the front to rear direction from a center of a thread shape, as illustrated in FIG. 8, are generally known. In FIGS. 7 and 8, reference numeral 11 indicates a tool blade edge. In addition, Japanese Patent Application Laid-Open No. 3-178722 discloses a cutting method in which a cutting position of a tool is relatively shifted by an arbitrary distance in the cutting direction with respect to a workpiece, as illustrated in FIGS. 9A to 9C, so as to finish a thread ridge surface in a final threading cycle of the single-edged cutting. In this cutting method, the final threading operation is achieved by setting values of a final depth of cut a and a shift coefficient β as parameters in advance.

In the cutting method according to prior art, the tool moves in the axis direction of the workpiece and cuts in the workpiece from the front side of the thread shape. For this reason, cut chips produced by the cutting are discharged to the front side in the tool movement direction. Accordingly, the cut chips adversely influence the cutting of the tool depending on a machine structure or a machining shape of a workpiece, with the result that the machining precision may be degraded by the cut chips.

In prior art, the phenomenon in which the cut chips produced by the cutting of the workpiece using the tool adversely affects the cutting of the tool noticeably occurs in a case where the threading cycle is performed inside a cylindrical hole (a thread shape) of a workpiece 9 with a bottom (which is not perforated) , as illustrated in FIG. 10. In this case, since the cut chips are stuck in the bottom of the thread shape and are not discharged to the outside, the cut chips adversely affect the cutting of a tool 10. Then, the cutting method, in which the cutting position of the tool is relatively sifted by an arbitrary distance with respect to the workpiece in the cutting direction so as to finish the thread ridge surface in the final threading cycle of the single-edged cutting, does not solve the problem in which the cut chips are stuck in the bottom of the thread shape and does not give any hint as to how to handle the cut chips. In FIG. 10, reference numeral 12 indicates the movement direction of the tool 10.

Even when the cutting operation is performed on the workpiece illustrated in FIG. 10 by any one of the methods illustrated in FIGS. 7 and 8 and FIGS. 9A to 9C, most of the cut chips produced by the cutting are discharged to the bottom of the cylindrical hole (which is not perforated) of the workpiece 9 and the cut chips are stuck in the bottom of the cylindrical hole as illustrated in FIG. 11. For this reason, a problem arises in that it takes trouble to discharge the cut chips. Alternatively, a problem arises in that the subsequent cutting operation by the tool 10 is disturbed, the machining precision is degraded, and hence the quality of the workpiece 9 is adversely affected. In FIG. 10, reference numeral 13 indicates a main cut-chip discharge direction.

Further, when the operation of causing the tool to cut in the workpiece from the bottom of the cylindrical shape (the inner side of the thread shape) is realized by repeating the threading instructions, without using the threading cycle, there is a need to calculate a threading instruction start point every time and hence it takes time to create a program.

### SUMMARY OF THE INVENTION

Therefore, it is an object of the invention to provide a numerical controller having a threading cycle function that discharges cut chips, produced by cutting of a tool to a workpiece, to a front side in a tool movement direction and does not need to calculate a threading instruction start point for each cycle in a case where an operation is instructed in which cutting operation is performed from an inner side of a thread shape (not from an inlet side).

The present invention relates to a numerical controller having a threading cycle function that analyzes a machining program in which a thread shape is instructed and performs machining of thread shapes with a plurality of cycles divided, wherein the numerical controller selects a cutting method in which cutting operation is performed from an inner side of a thread shape (from a bottom of a cylindrical hole) by an instruction of a program or a setting of a parameter or a signal and discharges cut chips, produced by cutting of a tool, to a front side (to an inlet side of a cylindrical hole) in a tool movement direction.

A numerical controller according to the present invention has a threading cycle function that performs threading on a workpiece by repeating an operation in which a tool is positioned at a cutting start position based on a machining program designating a thread shape and the tool is relatively moved in a workpiece axis direction with respect to the workpiece in synchronization with a rotation of a spindle. The numerical controller includes: a cutting start position calculating unit that calculates a cutting start position for each cycle so that cutting operation is sequentially performed in a direction opposite to the movement direction of the tool with respect to the workpiece, according to a threading instruction of the machining program; and a threading unit that positions the tool at the cutting start position calculated for each cycle and performs threading on the workpiece.

The machining program may be able to designate a thread cutting method, and the numerical controller may further comprise a determination unit that determines whether or not a cutting method of machining the workpiece while sequentially cutting the workpiece in a direction opposite to the movement direction of the tool with respect to the workpiece is instructed by the machining program. In this case, when the determination unit determines that the method of processing the workpiece while sequentially cutting the workpiece in a direction opposite to the movement direction of the tool with respect to the workpiece is instructed by the machining program, threading may be performed on the workpiece so that the workpiece is sequentially cut in a direction opposite to the movement direction of the tool with respect to the workpiece.

The numerical controller may further comprise: a storage unit that stores a plurality of thread cutting methods, and the cutting method of machining the workpiece while sequentially cutting the workpiece in a direction opposite to the movement direction of the tool with respect to the workpiece may be selected based on a parameter or a signal.

The numerical controller according to the present invention has a threading cycle function in which the thread shape is finished by the continuous cutting operation, and is configured to discharge the cut chips, produced by the cutting operation by the tool, to the front side (to the inlet side of the cylindrical hole) in the tool movement direction, since it is possible to easily select the method of cutting of the workpiece from the inner side of the thread shape (from the bottom of the cylindrical hole). Accordingly, it is possible to circumvent an adverse influence of the cut chips on the cutting operation by the tool. As a result, it is possible to reduce a trouble in the operation of discharging the cut chips or to improve the quality of machined workpieces. Further, since there is no need to calculate the threading instruction start point for each cycle when an operation is instructed in which the cutting operation is performed from the inner side of the thread shape, it is possible to reduce an operation time for creating the program.

### BRIEF DESCRIPTION OF THE DRAWINGS

The object and the characteristic of the invention will become clear from the following embodiments with reference to the accompanying drawings. In these drawings:

FIG. 1 is a diagram illustrating an example of a typical threading cycle.

FIG. 2 is a diagram illustrating a method of calculating a threading start position by single-edged cutting.

FIG. 3 is a diagram illustrating cutting of thread shape according to the invention.

FIG. 4 is a diagram illustrating a cut chip discharge direction in a case where the present invention is applied.

FIG. 5 is a block diagram illustrating a numerical controller that performs a threading cycle according to the invention.

FIGS. 6A and 6B are flowcharts illustrating a flow of the threading cycle.

FIG. 7 is a diagram illustrating an example of thread shape cutting (single-edged cutting) according to prior art.

FIG. 8 is a diagram illustrating an example of thread shape cutting (zigzag cutting) according to prior art.

FIGS. 9A to 9C are diagrams illustrating a thread shape cutting method according to prior art.

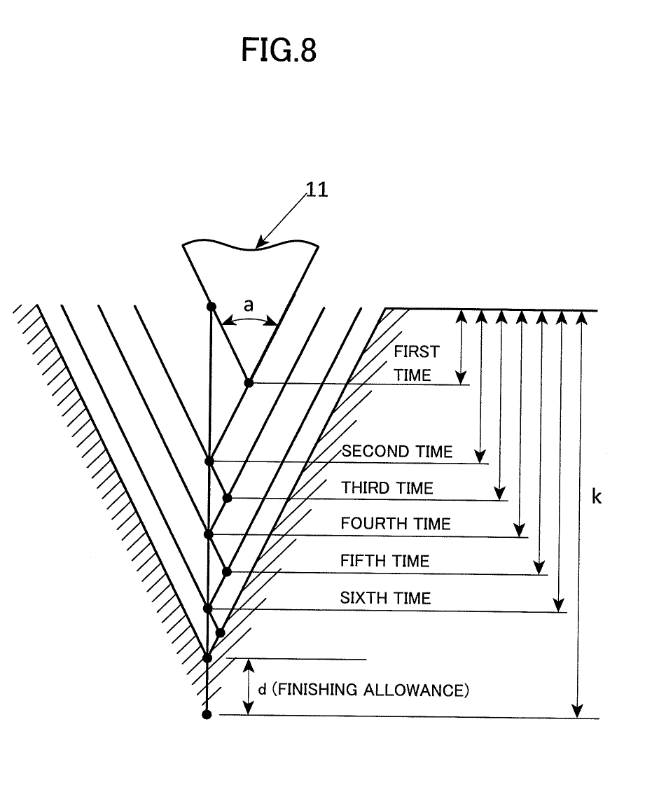

FIG. 10 is a diagram illustrating an example in which a threading cycle is performed on a workpiece to form a cylindrical bottomed thread shape.

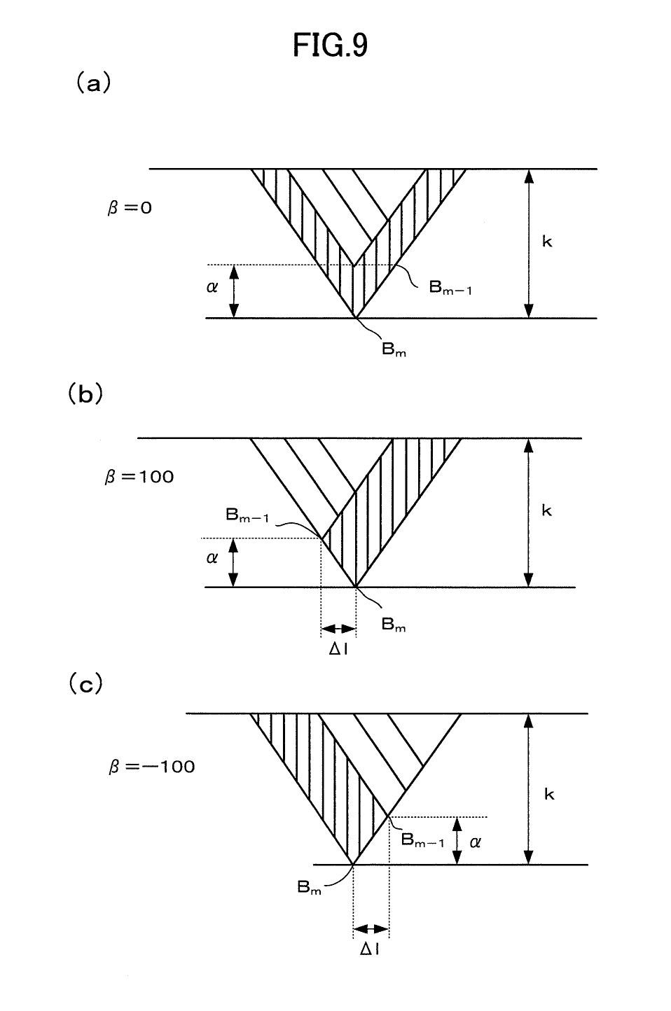

FIG. 11 is a diagram illustrating a cut chip discharge direction in a case where a cutting method according to prior art is applied.

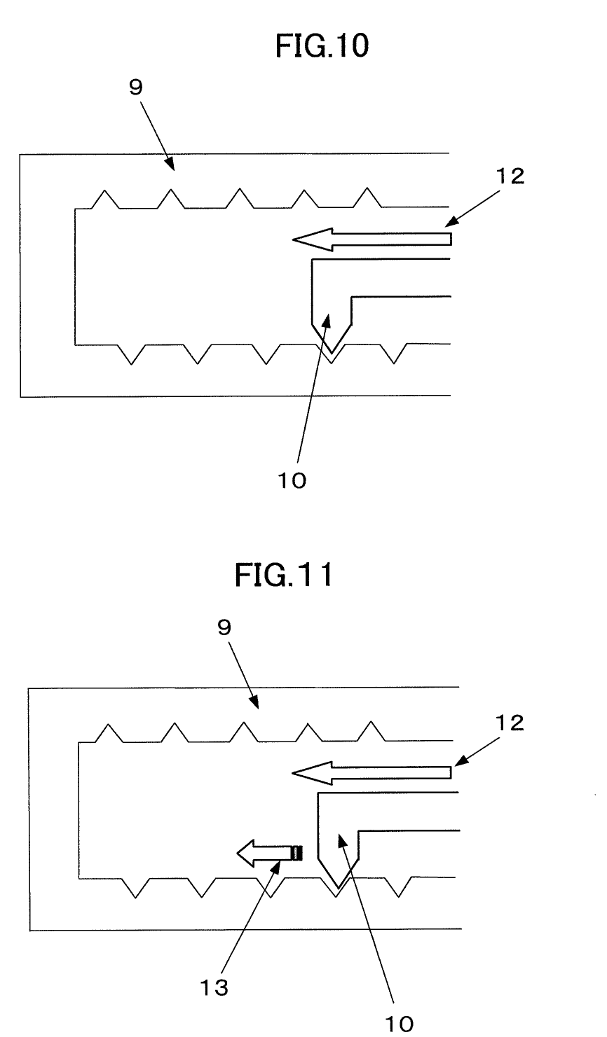

### DETAILED DESCRIPTION OF THE PREFERRED EMBODIMENTS

### Embodiment 1

In a threading cycle, when only a finished shape such as a height of a thread ridge and a first depth of cut are instructed, a halfway tool path is automatically determined and threading is performed along the tool path. More specifically, in the threading cycle, although the threading is repeated while the depth of cut is slightly changed so as to finally form an instructed thread shape in a workpiece, the depth of cut and the tool path for each threading cycle are automatically determined so that a thread with an instructed shape is machined.

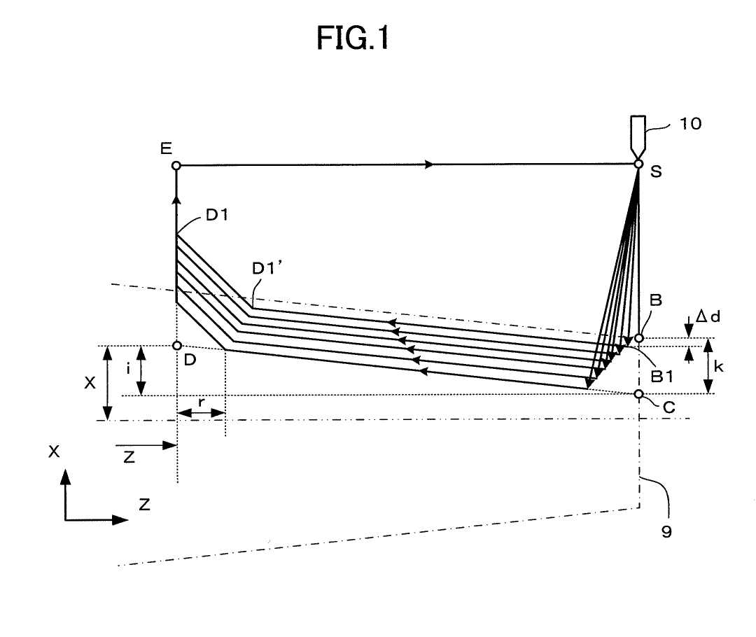

An example of a typical threading cycle is illustrated in FIG. 1.

A workpiece 9 is rotationally driven at a predetermined rotation speed about a two-dotted chain line of FIG. 1 when threading is performed by a tool 10. The position of a point D of FIG. 1 in the XZ coordinates is set as (X, Z). Reference symbol i indicates a radius difference in a thread portion, wherein the value i becomes 0 in a case of straight threading. Reference symbol k indicates a height (set as a distance in the X direction) of a thread ridge, Reference symbol Δd indicates a first depth of cut, and reference symbol r indicates a thread cutting amount. In a first process of the threading cycle, the tool 10 moves so as to follow the path of S→B1→D1→D1→E→S.

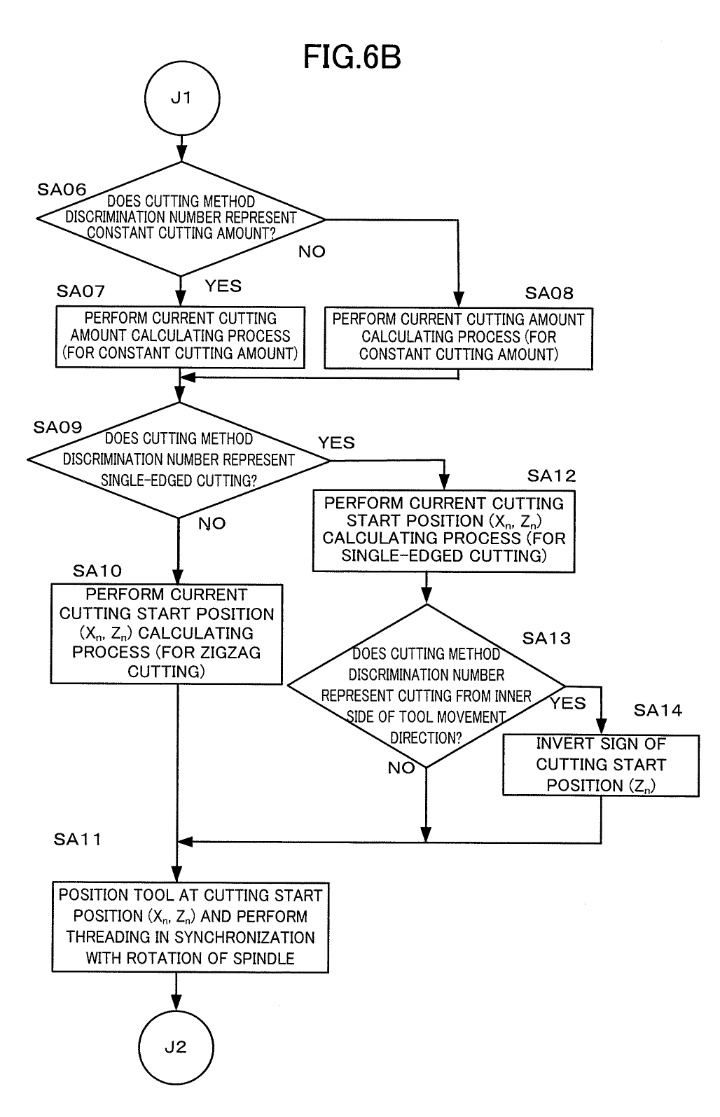

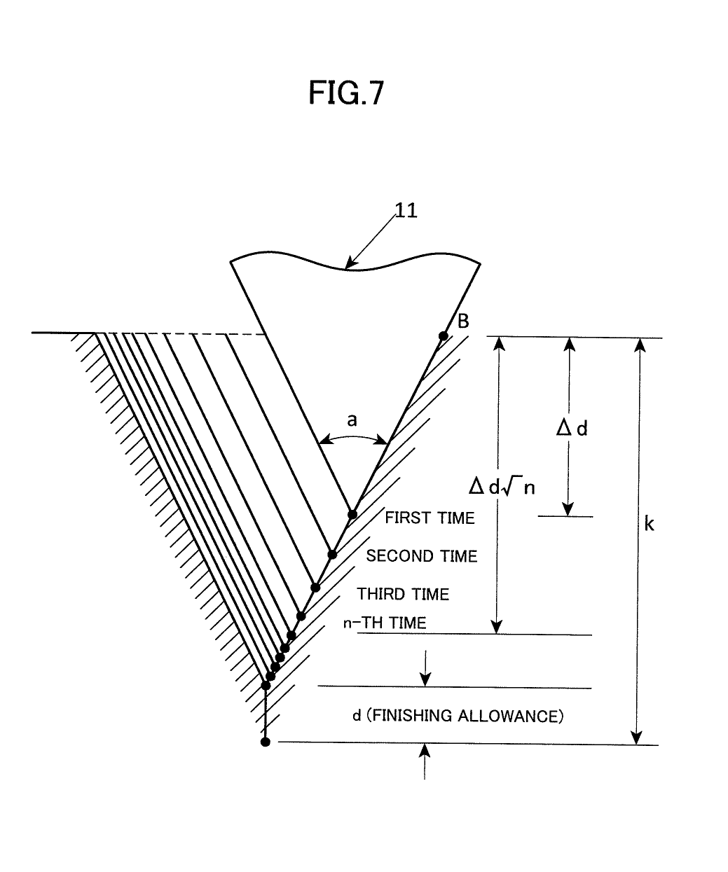

In general, single-edged cutting, as illustrated in FIG. 7, and zigzag cutting, as illustrated in FIG. 8, are known as a thread shape cutting method. Further, the cutting method becomes different depending on whether to keep the cutting amount constant or keep the depth of cut constant. Usually, in order to discriminate the thread shape cutting method, an unique number is given to each of the cutting methods, and the discrimination is performed by using the number.

For example, the following cutting method discrimination numbers are given to the respective cutting methods.

Discrimination number <1>: single-edged cutting with constant cutting amount

Discrimination number <2>: zigzag cutting with constant cutting amount

Discrimination number <3>: single-edged cutting with constant depth of cut

Discrimination number <4>: zigzag cutting with constant depth of cut

Discrimination number <5>: single-edged cutting with constant cutting amount, in which cutting is performed from an inner side of a thread shape

Discrimination number <6>: single-edged cutting with constant depth of cut, in which cutting is performed from an inner side of a thread shape

Next, described is a method of calculating a cutting start position for each cycle so that the workpiece is machined while sequentially cutting the workpiece in a direction opposite to the movement direction of the tool with respect to the workpiece by a threading instruction of a machining program, using a numerical controller according to the invention.

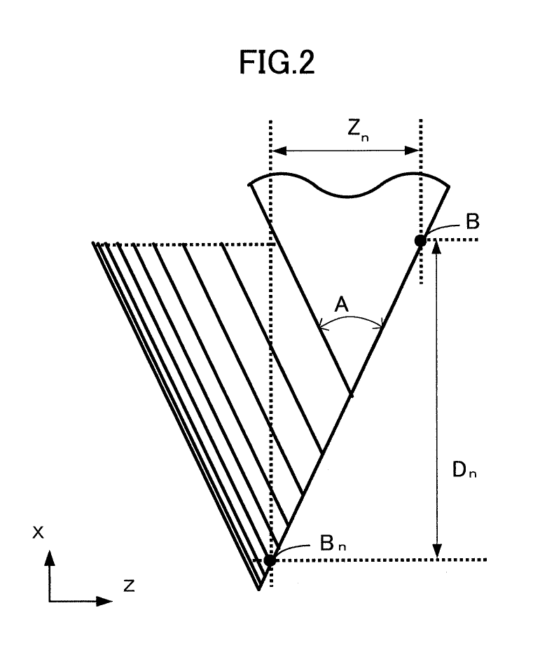

A method of calculating each cycle start point in a case where the single-edged cutting is applied in the threading cycle will be described by referring to FIG. 2.

It is assumed that the reference point at the cutting position is denoted by B and the n-th cycle start point is denoted by Bₙ. Then, when the movement amount (the depth of cut) in the X direction when viewed from the reference point B is denoted by Dₙ and the angle of a blade edge 11 is denoted by A, the movement amount Zₙ in the Z direction is obtained by the following equation (1).

$${Z}_{n} = {D}_{n} \cdot tan ( \frac{A}{2} ) \qquad ( 1 )$$

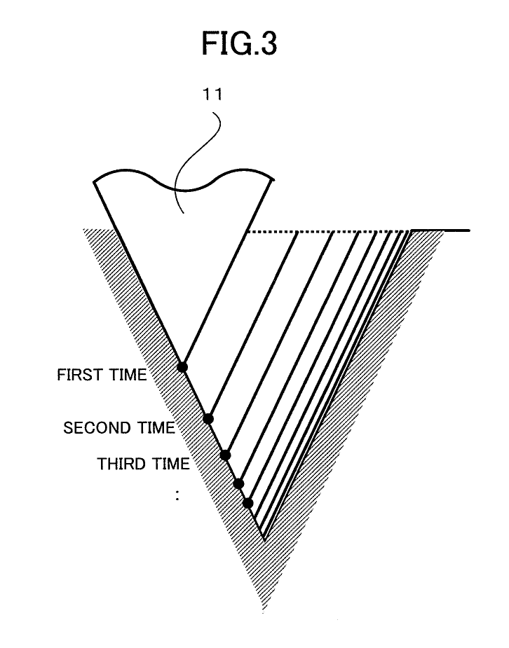

At this time, when the sign of the movement amount Zₙ in the Z direction, obtained by the above-described equation (1), is inverted, it is possible to determine the cycle start point when the cutting operation is performed from the inner side of the thread shape with respect to the movement of the tool (see FIG. 3).

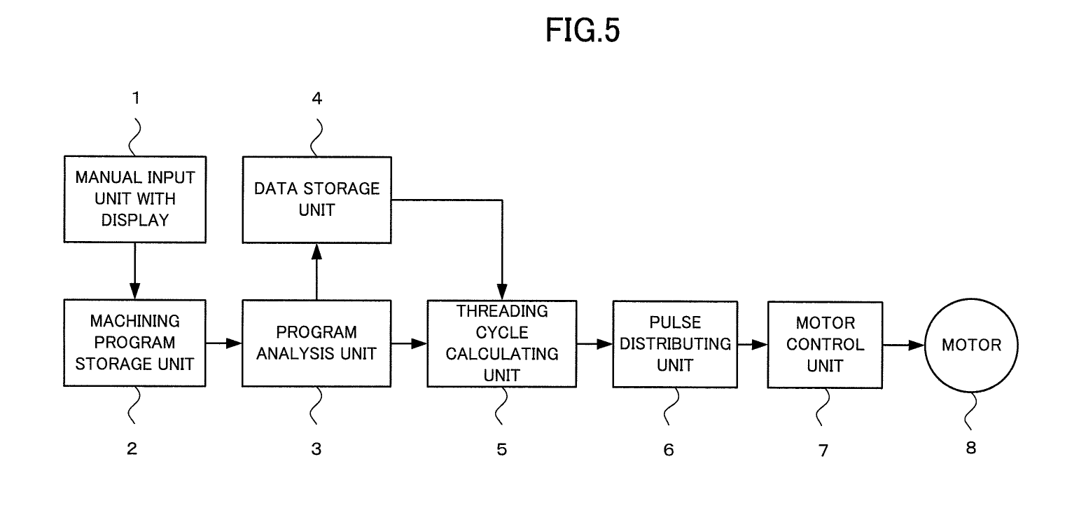

FIG. 5 is a functional block diagram illustrating an embodiment of the numerical controller that performs the threading cycle of the present invention.

A machining program which is registered in a machining program storage unit 2 by means of a manual input unit with display 1 is read by a program analysis unit 3 every block data. The program analysis unit 3 registers data (a height of a thread ridge, a first depth of cut, a thread cutting amount, and the like) necessary for executing a threading cycle, instructed in the program, in the data storage unit 4. Furthermore, the data necessary for executing the threading cycle may be registered in the data storage unit 4 by a parameter or a signal. The thread shape cutting method may also be registered in the data storage unit 4 by a program instruction, a parameter, or a signal. For example, the thread shape cutting method may be registered in the data storage unit 4 based on a signal generated by the pressing of a setting input button.

The thread cutting method may be designated by the machining program. Here, it is determined whether or not the cutting method of machining the workpiece while sequentially cutting the workpiece in a direction opposite to the movement direction of the tool with respect to the workpiece is instructed by the machining program, and the workpiece is processed based on the determination result. Further, the thread cutting method may be selected based on a parameter or a signal.

By using the information analyzed by the program analysis unit 3 and the data registered in the data storage unit 4, a threading cycle calculating unit 5 calculates the movement of the tool in the threading cycle. A pulse distributing unit 6 calculates the amount of pulses generated per unit time and transmits the amount of pulses to a motor control unit 7. The motor control unit 7 drives a motor 8 for moving the tool 10 so as to perform the threading cycle illustrated in FIG. 1.

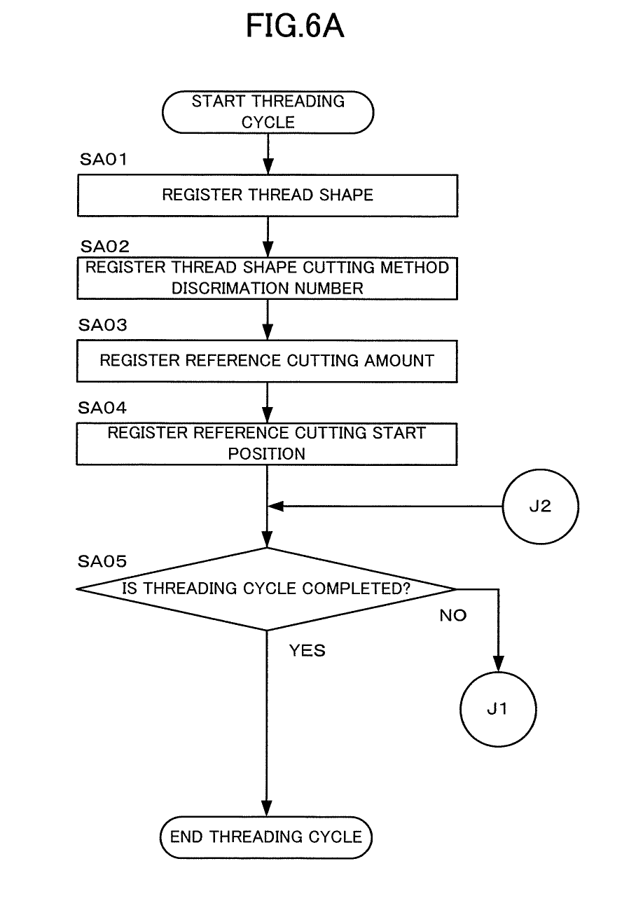

Next, a threading cycle process performed by the numerical controller (the program analysis unit 3, the data storage unit 4, and the threading cycle calculating unit 5) according to the invention will be described by referring to the flowcharts of FIGS. 6A and 6B.

When the threading cycle process is started, first, the machining program is analyzed and the thread shape is stored in the storage region (step SA01). Next, the thread shape cutting method discrimination number for discriminating the thread shape cutting method is determined from the machining program, the parameter setting, and the signal setting, and is stored in the storage region (step SA02). Next, the reference depth of cut D₀ is determined from the machining program and the parameter setting and is registered in the storage region (step SA03). Further, the first cutting start position (X₀, Z₀) of the cycle is registered as the reference cutting start position in the storage region (step SA04).

Next, it is determined whether the threading cycle is completed or not, more specifically, whether the cutting operation is performed until the workpiece is cut into the thread shape registered in previous step SA01 or not is determined (step SA05). Then, when it is determined that the threading cycle is completed (YES), the threading cycle process is ended. Meanwhile, when it is determined that the threading cycle is not completed yet (NO), it is then determined whether or not the cutting method discrimination number registered in previous step SA02 is a number representing a cutting method with a constant cutting amount (step SA06).

In step SA06, when the number is determined to represent the cutting method with a constant cutting amount (YES), the current depth of cut Dₙ is calculated from the reference depth of cut D₀ registered in previous step SA03, the number n of cutting operations, and the depth of cut calculating equation for the case where the cutting amount is constant (step SA07), and the routine proceeds to step SA09. Meanwhile, in step SA06, when the number is determined not to represent the cutting method with a constant cutting amount (NO), the current depth of cut Dₙ is calculated from the reference depth of cut D₀ registered in previous step SA03, the number n of cutting operations, and the depth of cut calculating equation for the case where the depth of cut is constant (step SA08), and the routine proceeds to next step SA09.

In step SA09, it is determined whether or not the cutting method discrimination number registered in previous step SA02 is a number representing a cutting method by single-edged cutting. Then, when it is determined that the number is not the number representing the cutting method by single-edged cutting (NO), the current cutting start position (Xₙ, Zₙ) is calculated from the reference cutting start position (X₀, Z₀) registered in previous step SA04, the current depth of cut Dₙ calculated in previous step SA07 or SA08, and the current cutting start position calculating equation for zigzag cutting (step SA10), and the routine proceeds to step SA11. Meanwhile, when it is determined that the number is the number representing the cutting method by single-edged cutting in step SA09 (YES), the current cutting start position (Xₙ, Zₙ) is calculated from the reference cutting start position (X₀, Z₀) registered in previous step SA04, the current depth of cut Dₙ, calculated in previous step SA07 or SA08, and the current cutting start position calculating equation for single-edged cutting (step SA12), and the routine proceeds to step SA13.

In step SA13, it is determined whether the cutting method discrimination number registered in previous step SA02 is a number representing a method of cutting the workpiece from the inner side of the thread shape with respect to the workpiece axis direction (the tool movement direction) by the tool. When it is determined that the number is not the number representing the method of cutting the workpiece from the inner side of the thread shape (NO), the routine proceeds to step SA11. Meanwhile, when it is determined that the number is the number representing the method of cutting the workpiece from the inner side of the thread shape (YES), the sign of the current cutting start position (Zₙ) is inverted (Zₙ=−Zₙ) (step SA14), and the routine proceeds to step SA11.

In step SA11, the cutting start position is determined as (Xₙ, Zₙ), and the tool is moved in the workpiece axis direction in synchronization with the rotation of a spindle so that a threading operation is performed on the workpiece held by the spindle. Subsequently, the routine returns to the determination in step SA05 again.

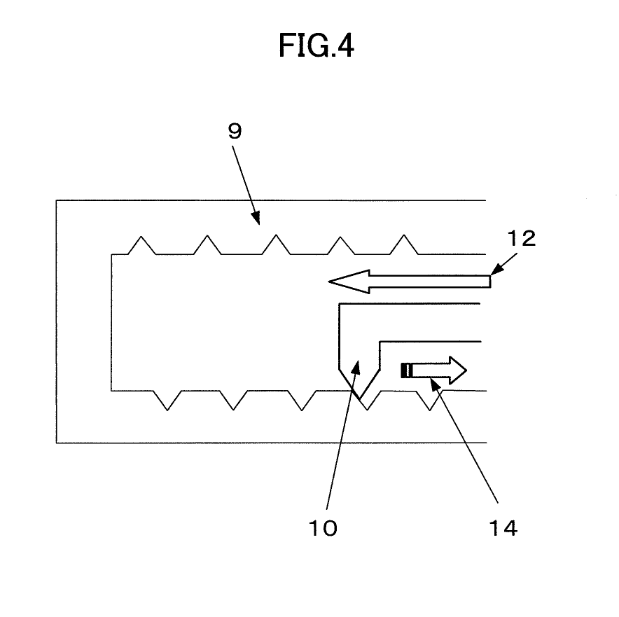

According to the invention, when the method of cutting the workpiece from the inner side of the thread shape with respect to the movement direction of the tool is employed (see FIG. 3), the cut chips are discharged to the front side of the movement direction of the tool as in FIG. 4. For this reason, it is possible to prevent degradation in machining precision caused by the cutting operation by the tool disturbed by the cut chips without the blockage of the produced cut chips. Furthermore, in FIG. 4, reference numeral 12 indicates the movement direction of the tool 10, and reference numeral 14 indicates the main cut-chip discharge direction.

Further, when the operation of cutting the workpiece from the inner side of the thread shape illustrated in FIG. 3 is instructed without using the threading cycle, it takes trouble to calculate the threading start position and to create a program for each cycle, in the case of prior art. However, according to the present invention, since there is no need to calculate the threading start point for each cycle, the operation time necessary for creating the program is reduced.

Furthermore, as in the case of prior art, in the final threading cycle of single-edged cutting, the cutting position may be relatively shifted in the cutting direction by an arbitrary value and the thread ridge surface may be finished.

1. A numerical controller having a threading cycle function that performs threading on a workpiece by repeating an operation in which a tool is positioned at a cutting start position based on a machining program designating a thread shape and the tool is relatively moved in a workpiece axis direction with respect to the workpiece in synchronization with a rotation of a spindle, the numerical controller with the threading cycle function comprising:
a cutting start position calculating unit that calculates a cutting start position for each cycle so that cutting operation is sequentially performed in a direction opposite to the movement direction of the tool with respect to the workpiece, according to a threading instruction of the machining program; and
a threading unit that positions the tool at the cutting start position calculated for each cycle and performs threading on the workpiece.

2. The numerical controller having the threading cycle function according to claim 1, wherein
the machining program is able to designate a thread cutting method, and
the numerical controller further comprises a determination unit that determines whether or not a cutting method of machining the workpiece while sequentially cutting the workpiece in a direction opposite to the movement direction of the tool with respect to the workpiece is instructed by the machining program, and
wherein when the determination unit determines that the method of processing the workpiece while sequentially cutting the workpiece in a direction opposite to the movement direction of the tool with respect to the workpiece is instructed by the machining program, threading is performed on the workpiece so that the workpiece is sequentially cut in a direction opposite to the movement direction of the tool with respect to the workpiece.

3. The numerical controller having the threading cycle function according to claim 1, further comprising:
a storage unit that stores a plurality of thread cutting methods,
wherein the cutting method of machining the workpiece while sequentially cutting the workpiece in a direction opposite to the movement direction of the tool with respect to the workpiece is selected based on a parameter or a signal.
